(19) United States
(12) Patent Application Publication
(10) Pub. No.: US 2026/0082470 A1
(43) Pub. Date: Mar. 19, 2026

(54) AUTO-CALIBRATED LINE-POWERED LED LIGHTING SYSTEM

(71) Applicant: Silicon Laboratories Inc., Austin, TX (US)

(72) Inventors: Michael D. Mulligan, Austin, TX (US); Bhavna Rachuri, Austin, TX (US)

(21) Appl. No.: 18/888,459

(22) Filed: Sep. 18, 2024

(51) Int. Cl. H05B 45/54; H05B 45/37

(52) U.S. Cl. CPC H05B 45/54; H05B 45/37

(57) ABSTRACT

A line-powered LED lighting system includes rectifier circuit to provide a rectified AC voltage on a voltage node. A power transistor is coupled to a control signal having an on-time and an off-time. An inductor is coupled between the rectified voltage node and a drain of the power transistor. Series coupled LEDs are coupled between the rectified voltage node and the drain of the power transistor in parallel with the inductor. Control logic periodically calibrates the on-time of the power transistor to achieve a predetermined peak inductor current. The control logic maintains the calibrated on-time constant for a plurality of switching cycles of the power transistor until a next calibration event. The on-time is calibrated at least once every N cycles of the rectified AC voltage, where N is an integer greater than or equal to 1.

### CROSS-REFERENCE TO RELATED APPLICATION(S)

This application relates to the application entitled “High Voltage Gate Driver Using Low Voltage Transistors With Input Voltage Referenced Supply Regulator”, application Ser. No. 18/770,247, filed Jul. 11, 2024, naming Michael D. Mulligan as inventor and this application relates to the application entitled “Timing Based Signal Valley Detection”, application Ser. No. 18/633,257, filed Apr. 11, 2024, naming Bhavna Rachuri and Michael D. Mulligan as inventors, which applications are incorporated by reference herein.

### BACKGROUND

### Field of the Invention

This application relates to electronic circuits in general and more particularly to calibrating the on-time of a power transistor.

### Description of the Related Art

A typical light-emitting diode (LED) system includes a string of series coupled LEDs, an inductor, and a power switch. An AC power supply is coupled to a rectifier and a capacitor to provide a rectified current or voltage. A control loop includes an LED driver that switches the power switch on and off. Switching performance and efficiency of the LED driver affects power losses and efficiency of the system. It is desirable to keep the system operating at desired performance levels.

### SUMMARY OF EMBODIMENTS OF THE INVENTION

In an embodiment the on-time of a power transistor in a power converter circuit is periodically calibrated in order to maintain the peak inductor current at a desired level.

In an embodiment a method includes periodically calibrating an on-time of a power transistor in a switching power converter during a calibration cycle by setting the on-time to have a length that results in a predetermined peak inductor current and keeping the on-time constant until a next calibration cycle.

In another embodiment an apparatus includes a power transistor coupled to a control signal having an on-time and an off-time. An inductor is coupled between a voltage node and the power transistor. Control logic periodically calibrates a length of the on-time to select the length that results in a predetermined peak inductor current. The control logic maintains the length of the on-time constant for subsequent switching cycles of the power transistor until a next calibration event.

In another embodiment an apparatus includes a rectifier circuit to provide a rectified AC voltage on a voltage node. A power transistor is coupled to a control signal having an on-time and an off-time. An inductor is coupled between the voltage node and a drain of the power transistor. Control logic periodically calibrates the on-time of the power transistor to achieve a predetermined peak inductor current. The control logic maintains the on-time that has been calibrated constant for a plurality of switching cycles of the power transistor until a next calibration event. The on-time is calibrated at least once every N cycles of the rectified AC voltage, where N is an integer greater than or equal to 1.

### BRIEF DESCRIPTION OF THE DRAWINGS

The present invention may be better understood, and its numerous objects, features, and advantages made apparent to those skilled in the art by referencing the accompanying drawings.

FIG. 1 illustrates an embodiment of a line powered LED lighting system.

FIG. 2 illustrates the inductor current during the power transistor on and off cycles.

FIG. 3 illustrates waveforms showing the rectified AC voltage, the peak inductor current during the power transistor on cycle (Ton) and the off cycle (Toff), and calibration operations to measure Ton to set the peak inductor current to the predetermined current level.

FIG. 4 illustrates logic for timing-based peak AC voltage detection used to determine when peak AC voltage occurs to start calibration of Ton at the next power transistor Ton cycle.

FIG. 5 illustrates a flow diagram for calibration operations for Ton.

The use of the same reference symbols in different drawings indicates similar or identical items.

### DETAILED DESCRIPTION

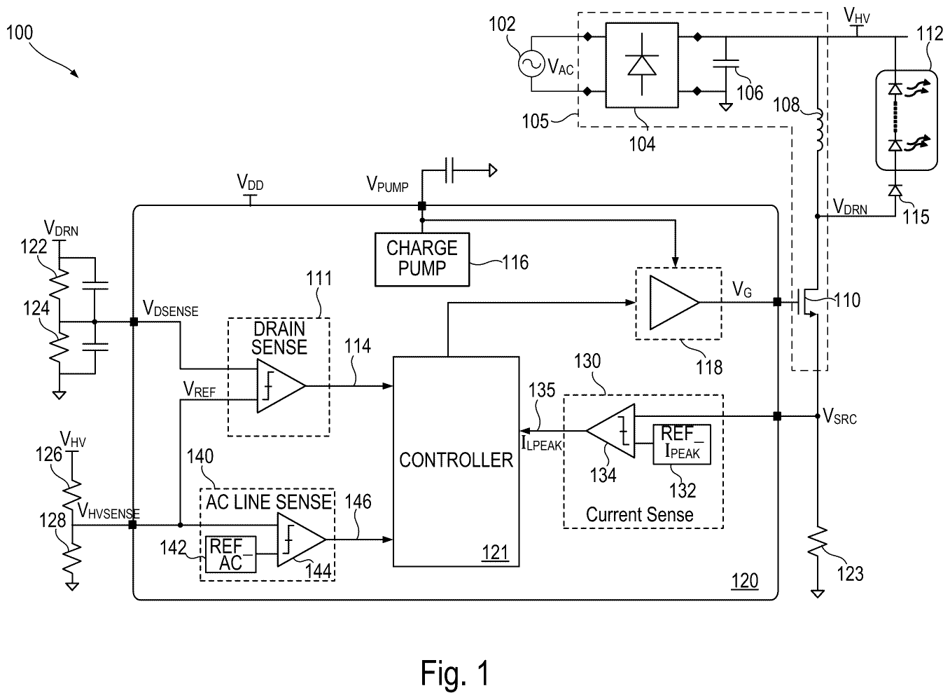

A light emitting diode (LED) lighting system periodically calibrates the on-time of a power transistor to generate a desired peak inductor current to limit the sources of inaccuracy due to aging, temperature drift, or other effects that may cause drift in the LED current. Once calibrated the on-time is kept constant until the next calibration cycle. FIG. 1 illustrates an embodiment of a line powered LED lighting system 100. The LED system receives alternating current (AC) line power from an AC source 102 at a rectifier 104 in a switching power converter 105 that rectifies the AC voltage and smooths the rectified voltage with capacitor 106 to generate the rectified high voltage V_{HV}. The system 100 further includes an inductor 108 and a power transistor 110. The LED string 112 and rectifying diode 115 are coupled in parallel with inductor 108. When power transistor 110 is turned on by the gate control signal V_{G} for an on period Ton, a current through inductor 108 increases and energy transfers to the magnetic field of inductor 108. When enough energy is stored by inductor 108, gate control signal V_{G} turns off power switch 110 for an off period Toff and inductor 108 delivers stored energy to the LED string 112. In the illustrated embodiment, the current through inductor 108 ramps down to zero during Toff and completely demagnetizes inductor 108 every period of gate control signal V_{G}. The length of Toff depends on the forward voltage across LEDs 112 and the peak inductor current. The forward voltage across the LEDs 112 produces a reverse voltage across the inductor 108 resulting in the inductor current ramping down. Charge pump 116 provides the high voltage necessary for drive circuit 118 to provide the control voltage V_{G} for power transistor 110. In at least one embodiment, the LED lighting system 100 includes an integrated circuit device 120 that includes a controller 121 providing control functionality used to periodically calibrate the on-time Ton to ensure that the peak inductor current remains at the target current level. The target current level is a predetermined current level that corresponds to a desired operating point. Of course the target current level can be fixed or dynamic. The peak current level is predetermined in that it is known prior to the calibration operation. In various embodiments the controller 121 may be a microprocessor, an embedded processor, an application specific integrated circuit, a programmable circuit, a microcontroller unit (MCU), or another similar device or combination of devices.

Note that the power transistor 110 may be a metal oxide semiconductor field effect transistor (MOSFET) as shown in FIG. 1, a bipolar junction transistor (BJT), an insulated gate bipolar transistor (IGBT), or any other type of power transistor suitable for the application and thus while V_{G} is described as a gate signal, more generally V_{G} is a control signal to turn on and off the power transistor.

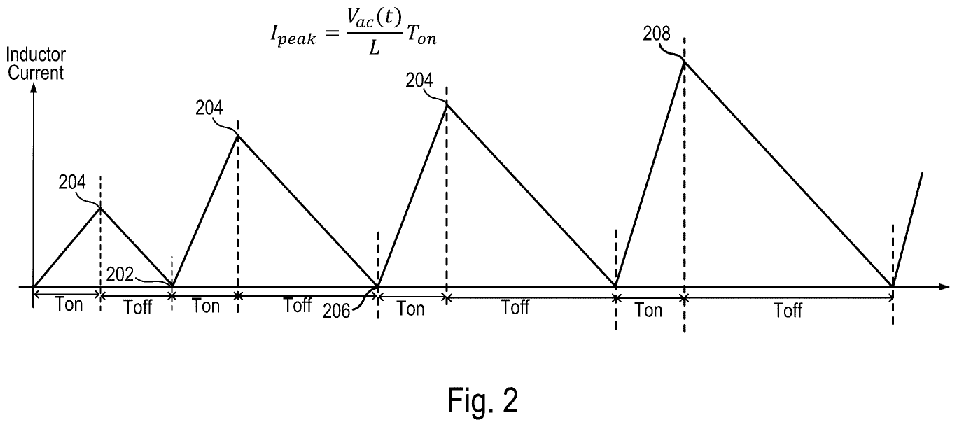

FIG. 2 illustrates the cycles of the inductor current as the gate signal V_{G} turns the power transistor 110 on and off. The inductor currents ramps up during Ton, which starts with the detection of the inductor current reaching zero at 202 indicating the end of Toff and the beginning of Ton and lasting until the inductor current peaks at 204 where the power transistor is turned off. In the illustrated embodiment Ton is fixed and results in a cycle-by-cycle peak current Iₚₑₐₖ that depends on the rectified AC voltage Vac. The peak current is represented by the equation

$${I}_{p e a k} = \frac{{V}_{ac} ( t )}{L} {T}_{o n} ,$$

where Vac is the rectified voltage, Ton is the length of time that the power transistor is turned on, and L is the inductor value. Note that Toff immediately follows Ton and lasts from the inductor peak current until the next zero detect at 206. The length of Toff depends on the forward voltage across the LEDs (reverse voltage across the inductor 108) and the magnitude of the inductor peak current at 204. The illustrated mode of operation is referred to as boundary conduction mode (BCM) in which the end of Toff starts Ton and the end of Ton starts Toff. In the illustrated embodiment, Ton is constant except during the calibration cycle. During the Ton cycle ending at 208, the peak current is recalibrated by measuring the voltage across sense resistor 123 (see FIG. 1) and comparing the sensed voltage to a reference voltage as explained more fully herein.

In order to periodically calibrate the peak inductor current, the LED lighting system needs to know when Ton starts, when the target peak inductor current is reached, as well as when to periodically calibrate. Each of these conditions will be taken in turn. Ton starts in the illustrated embodiment with the inductor current zero crossing as shown at 202 in FIG. 2. In an embodiment zero crossing detection uses a valley switching approach that uses the resonance of the parasitic capacitance of the power switch 110 and the inductor 108 to determine when to turn on a signal for a next switching cycle. The valley switching approach turns on the power transistor control signal, e.g., V_{G}, at a point when the voltage at the resonant node (V_{DRN}) is at a local minimum to reduce power loss and increase efficiency. Typical implementations of the valley switching method use analog circuits (e.g., switched capacitor circuits that sample a signal and a circuit that compares two most recent samples) to detect the valley in the resonant signal. Another embodiment utilizes a timing-based valley detection approach.

Referring again to FIG. 1, in at least one embodiment, resistive voltage divider circuits formed by resistors 122 and 124 and resistors 126 and 128, generate respectively sensed voltages V_{DSENSE} (voltage divided drain voltage (V_{DRN}) of the power transistor 110) and V_{HVSENSE} (voltage divided rectified high voltage (V_{HV})). V_{HVSENSE} is supplied to AC line sense circuit 140. In one or more embodiments V_{HVSENSE} also function as a reference voltage V_{REF}, which is used for comparison to V_{DSENSE}. The voltage dividers ensure that the sensed voltages are low enough to be compatible with a low voltage device, e.g., having a voltage supply of 3.3V or lower, such as an integrated circuit 120. The resistors 122 and 126 can be several orders of magnitude larger than the resistors 124 and 128 to achieve the required voltage division. The “valley” detect (zero crossing) using a timing based signal valley detection approach is described in detail in the application entitled, “Timing Based Signal Valley Detection”, application Ser. No. 18/633,257, filed Apr. 11, 2024, which application was incorporated by reference above. Briefly, to initially predict where the valley occurs the sensed value of the drain voltage V_{DSENSE} is compared to the reference voltage V_{REF} in comparator circuit 111. When the sensed value of the drain voltage crosses below the reference voltage V_{REF} the comparator output 114 asserts and responsive thereto a counter begins counting and counts until the drain voltage crosses above reference voltage V_{REF}. Assuming the drain voltage is symmetrical, dividing the counter value by two gives the timing of the minimum voltage where the valley (zero crossing) occurs. In order to predict the valley for calibration purposes, when the sensed drain voltage crossed below the threshold, the counter counts until the divide by two value is reached, which indicates the valley. Thus, the timing-based valley detect adjusts the duty cycle of gate control signal V_{G} by terminating the off time of the power transistor 110 and starting the on-time of power transistor 110 at a time corresponding to an estimated occurrence of the valley in drain voltage V_{DRN}.

Of course, other embodiments may use different approaches to detect the valley (when Ton starts), including, e.g., other implementations of the valley switching approach that use analog circuits as described above.

Referring to FIGS. 1 and 2, the peak inductor current occurs at 204 in FIG. 2 when Ton ends and the power transistor turns off to start Toff. In order to measure the peak current for calibration purposes, current sense comparator circuit 130 receives the sensed source voltage (V_{SRC}) of power transistor 110 across sense resistor 123 and compares that sensed voltage to the reference voltage REF_I_{PEAK} 132 that corresponds to the predetermined peak inductor current. In order to calibrate the Ton cycle, at the beginning of Ton in the calibration cycle a counter in controller 121 begins counting responsive to the zero crossing of the inductor current (however detected). That counter may be, e.g., a counter in an MCU forming controller 121. The counter counts until the comparator 134 indicates that the sensed voltage V_{SRC} has reached the reference voltage REF_I_{PEAK} 132 indicating that the peak current has reached the target peak current. That count value is then used to set the length of Ton as the constant value used until the next calibration cycle.

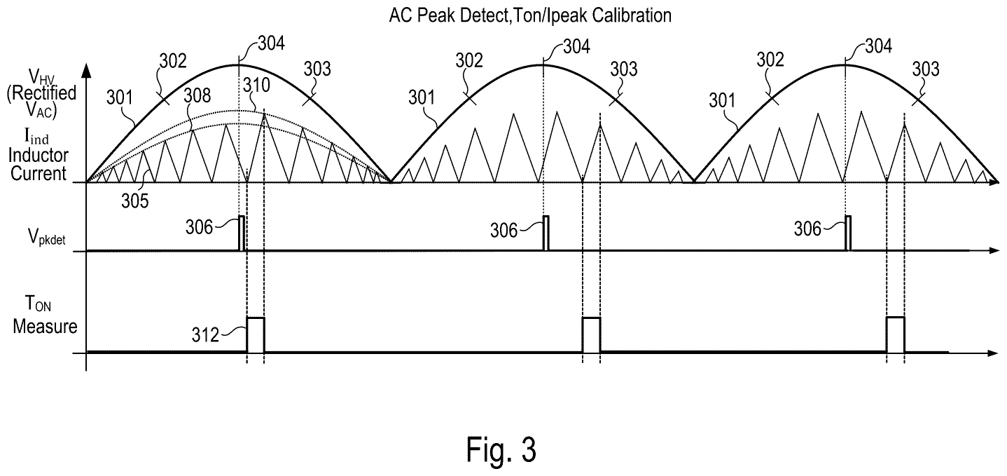

The system also needs to determine when to perform the periodic calibration. FIG. 3 shows the rectified AC voltage cycles 301. The peaks of the inductor current 305 as shown in FIG. 3, track the AC voltage as described by the equation for Iₚₑₐₖ above. As the AC voltage gets larger, the peak current is larger and as the AC voltage gets smaller during a Vac cycle, the peak current gets smaller. Therefore, in order to calibrate properly, it is necessary to calibrate at the particular point of the rectified AC cycle where the peak current should be nominally the same. In an embodiment of power converter 105, AC power source 102 has a line frequency of, e.g., 60 Hz, which is much lower than the switching frequency of power transistor 110 (e.g., 150-400 kHz) and the operating frequency of the integrated circuit 120, e.g., 5-40 MHz. Thus, while FIG. 3 shows only 10 switching cycles during a cycle of the rectified AC signal for ease of illustration, in fact thousands or tens of thousands of switching cycles may occur during each rectified AC cycle.

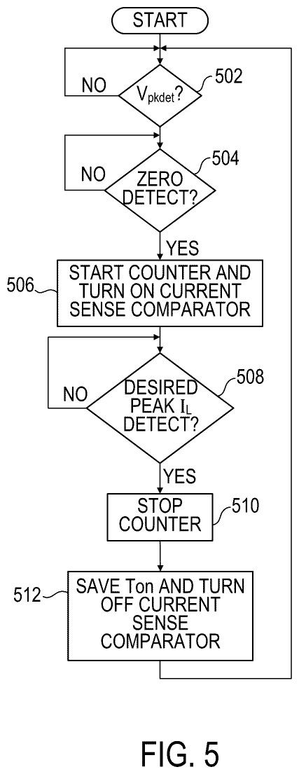

In an embodiment the AC line sense circuit 140 compares V_{HVSENSE} (voltage divided V_{HV}) to the AC reference 142 in comparator 144. As noted above, in some embodiments V_{HVSENSE} and V_{REF} are the same voltage while in other embodiments the reference voltages are different. Referring to FIG. 3, the particular point during the AC voltage cycle may be point 302 and/or 303. Thus, the calibration operation may start responsive to the AC voltage equaling the AC reference voltage (REF_AC) at 302 as the rectified AC voltage is rising or when the AC voltage equals the AC reference voltage (REF_AC) at 303 as the AC rectified voltage is falling, or both. Thus, the rising or falling edge of the comparator output signal 146, usually used to enable a counter to measure the AC peak, can also be used to indicate the calibration point. Reaching the calibration point triggers the calibration operation that measures the length of Ton required to achieve the target inductor current as explained more fully with relation to FIG. 5.

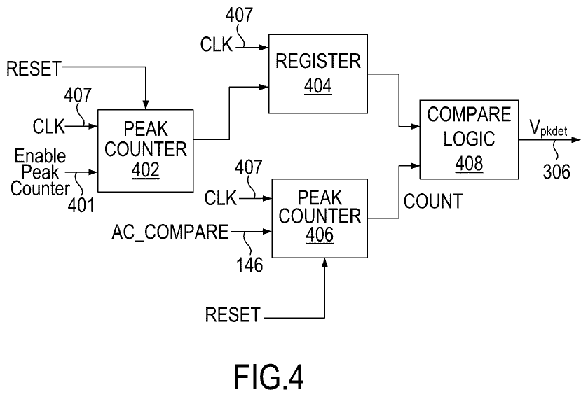

In another embodiment, the system 100 calibrates at the peak 304 of the rectified AC line voltage as shown in FIG. 3. In an embodiment a timing-based peak detection (or prediction) similar to the timing-based valley detection is used. Thus, referring to FIGS. 1 and 4, when V_{HVSENSE} crosses above the AC reference voltage (REF_AC) 142, which reference voltage is below the peak voltage, the comparator 144 supplies an asserted signal 146 to controller 121. That results in enable peak counter signal 401 to assert causing peak counter 402, which also receives clock signal 407, to begin counting. The counter continues to count until REF_AC 142 again becomes larger than V_{HSENSE} as the rectified AC voltage begins to decrease at which point enable peak count signal 401 is deasserted and the counter 402 stops counting. The count value generated by peak counter 402 is divided by two, e.g., by a right shift, and stored in register 404 as the divide by two value to be used to determine (predict) the AC voltage peak and the counter is reset. The timing-based peak detect approach assumes a symmetrical AC waveform and the divided by two value indicates how far the peak AC voltage is from the assertion of the comparator output 146. Note that the various comparator circuits shown in 111, 130, and 140 can use various circuit topologies according to system needs.

Referring still to FIG. 4, operationally, when the output 146 of comparator circuit 144 asserts the peak counter 406 starts counting. The compare logic 408 compares the count value to the stored divide by two count value in register 404. When equal, the compare logic supplies the peak detect signal V_{pkdet} and resets the counter. While two counters are shown in FIG. 4 for ease of explanation, a single counter, may of course be used for both functions represented by counters 402 and 406. Further, the functionality illustrated by FIG. 4 as well as other control functions described herein can be implemented using appropriate registers and counter(s) of an MCU functioning as controller 121 and firmware and/or software stored in memory (not shown) and executing on the MCU.

FIGS. 3 and 5 illustrate the Ton calibration operation. In an embodiment that initiates calibration at the peak of the rectified AC signal, the peak is detected at 304 using the logic illustrated in FIG. 4 resulting in the V_{pkdet} signal shown at 306. In FIG. 5, in response to assertion of V_{pkdet} in 502, the control logic looks for the start of the next Ton cycle in 504 when the inductor current is zero as shown at 202 in FIG. 2. In embodiments that use other than peak detect for the particular point of the alternating current (AC) voltage cycle to trigger calibration, e.g., at a particular voltage 302 and/or 304 (see FIG. 3) or another particular point of the AC voltage cycle, step 502 involves waiting for that particular point of the cycle to be detected by a voltage comparator, e.g., comparator 144 or another comparator not shown. Once the particular point in the AC cycle is detected (the AC peak or another particular point), the control logic looks for the start of the next Ton cycle in 504, which is indicated by the zero detect. With the start of the next Ton cycle, the control logic causes a Ton counter to start counting in 506 and turns on the current sense comparator circuit 130. Note that the AC voltage peak at 304 (or other predetermined point in the AC cycle) is asynchronous with respect to the Ton cycle measured for calibration but because there are thousands of Ton cycles in each AC cycle, the error due to Ton starting only nominally at the same point in the AC cycle is small enough and can be ignored. The counter continues to count until the control logic receives the signal I_{LPEAK} 135 in 508 indicating the target peak inductor current has been reached at which point the control logic stops the counter in 510 and turns off the current sense comparator circuit 130. Finally, the calibration operation saves the counter contents (Ton) in 512. The control logic then returns to 502 to wait for the next V_{pkdet} signal.

Note that the peak inductor current with a constant Ton can change due to aging, temperature, or other changing parameters, which is addressed by periodic calibration. Referring to FIG. 3, the first curve 308 represents the curve of the inductor current peaks that occur prior to Ton calibration and the curve 310 represents the inductor current peaks that occur after the Ton calibration that occurs at 312. Of course, the scale of the differences in the peaks that occur are exaggerated in FIG. 3 in order to illustrate the effects of calibration. In an embodiment, the calibration of Ton to achieve the target peak current repeats every peak of the rectified AC cycle, or every N peaks, where N is an integer and in embodiments is a programmable value. Thus, the peak detect step 502 may wait for N peak detects. More generally, step 502 is waiting for the next calibration cycle, however it is determined. While the embodiment in FIG. 1 uses AC line voltage, other embodiments may use a DC voltage in which case calibration may occur at periodic intervals rather than at the same point in the AC cycle since with a DC voltage supply there is no cycle.

Thus, techniques for calibrating the on-time Ton of a power switch in an LED lighting system has been described to ensure the peak inductor current is maintained at a target level in the presence of aging, temperature change, or other parameters that change and effect the peak inductor current. The description of the invention set forth herein is illustrative and is not intended to limit the scope of the invention as set forth in the following claims. The terms “first”, “second”, “third”, and so forth, as used in the claims, unless otherwise clear by context, are to distinguish between different items in the claims and do not otherwise indicate or imply any order in time, location or quality. Variations and modifications of the embodiments disclosed herein may be made based on the description set forth herein, without departing from the scope of the invention as set forth in the following claims.

What is claimed is:

1. A method comprising:
periodically calibrating an on-time of a power transistor in a switching power converter during a calibration cycle by setting the on-time to have a length that results in a predetermined peak inductor current; and
keeping the on-time constant until a next calibration cycle.

2. The method as recited in claim 1 further comprising periodically calibrating the on-time responsive to being at a particular point of an alternating current (AC) voltage cycle.

3. The method as recited in claim 2 further comprising calibrating the length of the on-time starting at a zero crossing of the inductor current that occurs following the particular point of the AC voltage cycle.

4. The method as recited in claim 2 wherein the particular point is a peak of the AC voltage cycle.

5. The method as recited in claim 2 where in the AC voltage cycle is a rectified AC voltage cycle.

6. The method as recited in claim 1 wherein the on-time is periodically calibrated every predetermined time period.

7. The method as recited in claim 1 wherein the calibrating further comprises:
starting a counter responsive to a zero crossing of the inductor current;
comparing a first voltage corresponding to the inductor current to a second voltage corresponding to the predetermined peak inductor current;
stopping the counter counting responsive to the first voltage corresponding to the inductor current crossing the second voltage corresponding to the predetermined peak inductor current; and
saving a count value in the counter as the length of time for the on-time of the power transistor.

8. The method as recited in claim 1 further using boundary conduction mode switching in which the on-time immediately follows an off-time of the power transistor.

9. The method as recited in claim 1 further comprising supplying power using the switching power converter to a string of light emitting diodes (LEDs).

10. An apparatus comprising:
a power transistor coupled to a control signal having an on-time and an off-time;
an inductor coupled between a voltage node and the power transistor;
control logic to periodically calibrate a length of the on-time to select the length that results in a predetermined peak inductor current; and
wherein the control logic maintains the length of the on-time constant for subsequent switching cycles of the power transistor until a next calibration event.

11. The apparatus as recited in claim 10 further comprising:
a rectifier circuit to provide a rectified AC voltage on the voltage node; and
an inductor coupled between the voltage node and a drain of the power transistor.

12. The apparatus as recited in claim 11 further comprising a string of light emitting diodes (LEDs) coupled between a drain of the power transistor and the voltage node.

13. The apparatus as recited in claim 10 wherein the length of the on-time is calibrated at a particular point of an AC voltage cycle.

14. The apparatus as recited in claim 13 further comprising a counter to count the length of the on-time that starts counting responsive to a first zero crossing of an inductor current that occurs following the particular point of the AC voltage cycle and ending responsive to current through the inductor current reaching the predetermined peak inductor current.

15. The apparatus as recited in claim 14 further comprising:
a comparator to compare a voltage corresponding to the inductor current to a reference voltage corresponding to the predetermined peak inductor current; and
wherein the counter stops counting responsive to the inductor current reaching the predetermined peak inductor current.

16. The apparatus as recited in claim 14 wherein the particular point is a peak of the AC voltage cycle.

17. The apparatus as recited in claim 16 further comprising a peak detect circuit to detect the peak of the AC voltage.

18. The apparatus as recited in claim 17 wherein the AC voltage is a rectified AC voltage.

19. The method as recited in claim 1 further using boundary conduction mode switching in which the on-time immediately follows an off-time of the power transistor.

20. An apparatus comprising:
a rectifier circuit to provide a rectified AC voltage on a voltage node;
a power transistor coupled to a control signal having an on-time and an off-time;
an inductor coupled between the voltage node and a drain of the power transistor;
control logic to periodically calibrate the on-time of the power transistor to achieve a predetermined peak inductor current;
wherein the control logic maintains the on-time constant for a plurality of switching cycles of the power transistor until a next calibration event; and
wherein the on-time is calibrated at least once every N cycles of the rectified AC voltage, where N is an integer greater than or equal to 1.
